(19) United States
(12) Patent Application Publication
(10) Pub. No.: US 2017/0047652 A1
(43) Pub. Date: Feb. 16, 2017

(54) SYSTEM AND METHOD FOR PROTECTING A USER OF A MOBILE ELECTRONIC DEVICE FROM RADIATION

(71) Applicant: ADERET INNOVATIONS LTD, Kiriat Matalon Petah-Tikva (IL)

(72) Inventors: Vladimir Finkel, Jerusalem (IL); YAFIM-HAIM PERLOV, Jerusalem (IL); MIKHAIL FINKEL, Jerusalem (IL); NOAH BELL, Jerusalem (IL); POLINA BENDETSKAYA, Jerusalem (IL)

(73) Assignee: ADERET INNOVATIONS LTD, Kiriat Matalon Petah-Tikva (IL)

(21) Appl. No.: 14/823,872

(22) Filed: Aug. 11, 2015

(51) Int. Cl. H01Q 1/52

(52) U.S. Cl. CPC H01Q 1/526

(57) ABSTRACT

In a system for protecting a user of a mobile electronic device from radiation, an operating unit operates for carrying out functional operations of a mobile electronic device, at least one antenna emits and receives signals in the mobile electronic device, and at least one element provides at least partial protection of a user from radiation by reflecting or absorbing radiation.

### BACKGROUND OF THE INVENTION

The present invention relates to systems and method of protecting users of mobile electronic devices from radiation.

Attempts have been made to protect users of mobile electronic devices, such as for example cellular phone from radiation which is considered undesired and harmful. Some proposed approaches included layered sheets for attenuation of near-field electromagnetic waves, the use of stamped metal parts for reducing near-field radiation and SAR values, radio reflective materials used between a phone and a user, metallic radio reflective shields used on the back of a phone, with antenna elements for passage of cellular signals, radio shielding phone cases, SAR reducing phone cases.

It is believed that the known systems and methods of this type can be further improved.

### SUMMARY OF THE INVENTION

In keeping with this object and others, it is therefore one feature of the present invention to provide a system for protecting a user of a mobile electronic device from radiation which includes a unit for carrying out functional operations of a mobile electronic device, at least one antenna emitting/receiving signals in the mobile electronic device, and at least one element providing at least partial protection of a user from radiation.

According to another feature of the present invention, the at least one element is configured to at least partially reflect the radiation away from the user.

According to a further feature of the present invention, the at least one element is configured to at least partially absorb the radiation.

According to a further feature of the present invention, the at least one element is a multi-layered film.

According to a further feature of the present invention, the at least one element operates in conjunction with the at least one antenna.

A method for protecting a user of a mobile electronic device from radiation includes the steps of carrying out functional operations by a unit for carrying out the functional operations of a mobile electronic device, emitting/receiving signals in the mobile electronic device by at least one antenna, and providing by at least one element for at least partial protection of a user from radiation.

According to another feature of the present invention, the step of providing protection includes at least partially reflecting the radiation away from the user by the element.

According to a further feature of the present invention, the step of providing protection includes at least partially absorbing the radiation by the element.

According to a further feature of the present invention, the at least one element is a multi-layered film.

According to a further feature of the present invention, the method includes operating the at least one element in conjunction with the at least one antenna.

The novel features of the present invention are set forth in the appended claims.

The invention itself is described in the following description of the preferred embodiment which is accompanied by the following drawings.

### BRIEF DESCRIPTION OF THE DRAWINGS

FIG. 1 is a view schematically showing an existing mobile electronic device;

FIG. 2 is a view schematically showing a mobile electronic device according to the present invention;

FIGS. 3-10 are views illustrating principles of operation of the existing mobile electronic device and of the mobile electronic device according to the presented invention based on some comparative examples.

### DESCRIPTION OF THE PREFERRED EMBODIMENTS

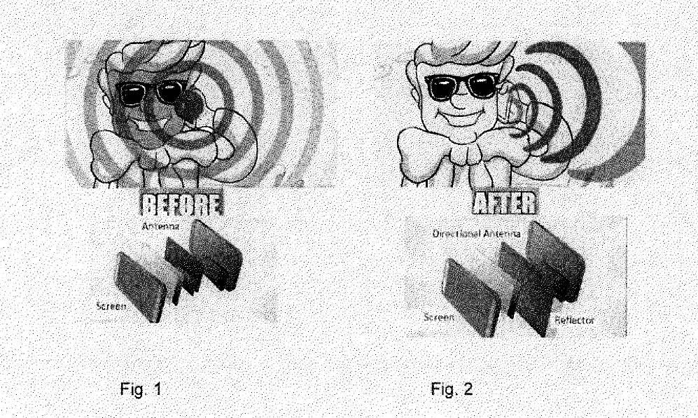

The invention consists in the creation of a directional energy emission that reduces SAR levels, by the conjunction usage of emitting/receiving existing different antennas in mobile devices (like cellular phones and others) and an element in form of a thin layered film that is integrated in the mobile electronic device or outside of it, acting as a reflector and/or absorber as illustrated in FIG. 2, contrary to existing mobile electronic device shown in FIG. 1

Energy absorption by the human body due to the radiation used to connect mobile devices to communications networks is considered an undesired effect while the implications of the absorbed radiation are under extensive research.

This method comes to define an integrated antenna as a way to direct the emitted energy outwards while reducing significantly the energy absorbed in the human body, depending on the mobile device location towards the body.

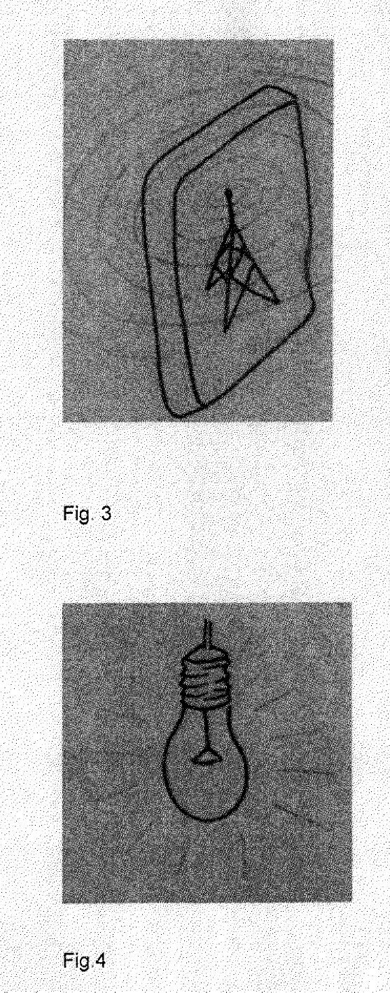

Regular existing antennas in mobile devices are transmitting according to their actual transmission lobes. As an example, we can see an omnidirectional antenna transmitting to all directions as appearing in FIG. 3 of the drawings.

This transmission can be explained using the regular Incandescent lamp, emitting light to all directions, as shown in FIG. 4 of the drawings.

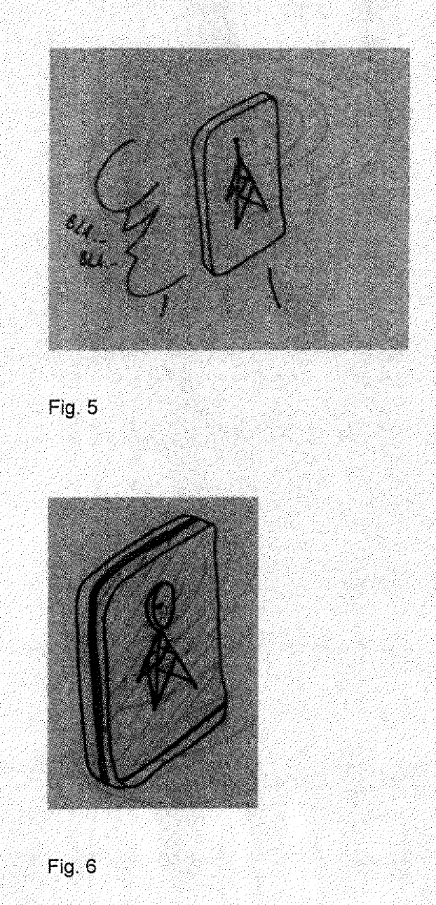

As a result of this transmission, transmitted energy is absorbed in the human body, as shown in the scheme of FIG. 5.

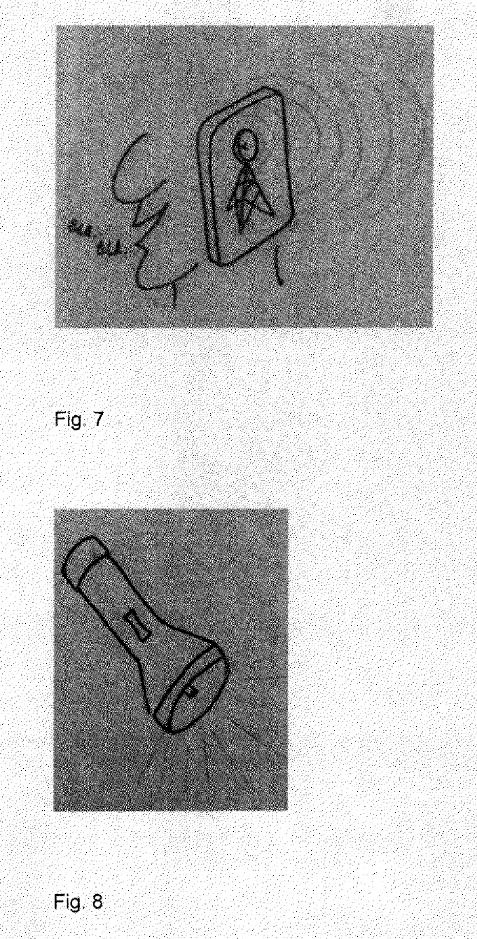

In contrast to this situation, the integrated antenna detailed in this patent application, directs energy outwards of the human body, as described in the following schemes in FIGS. 6 and 7.

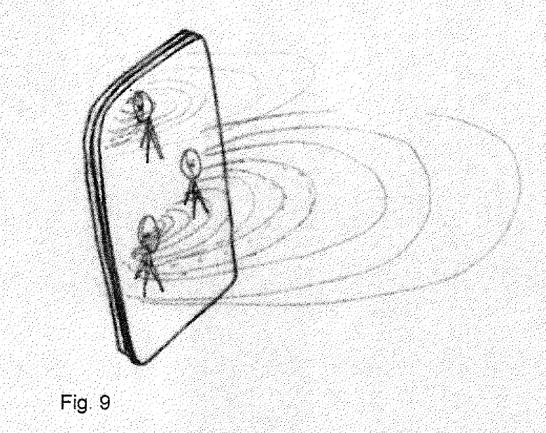

It resembles the operation of a flashlight, where the light is directed by the reflector as shown in FIG. 8.

The element formed as multi-layered film, acts in a similar way to the function the dish performs in a parabolic antenna. In contrast to the regular parabolic antenna that uses the dish for a single feed antenna, our method allows not only to direct the energy outwards but to do it for different antennas installed in mobile devices, thus lowering the energy absorbed for different type of transmissions in the relevant frequency range, as seen in the illustration of FIG. 9.

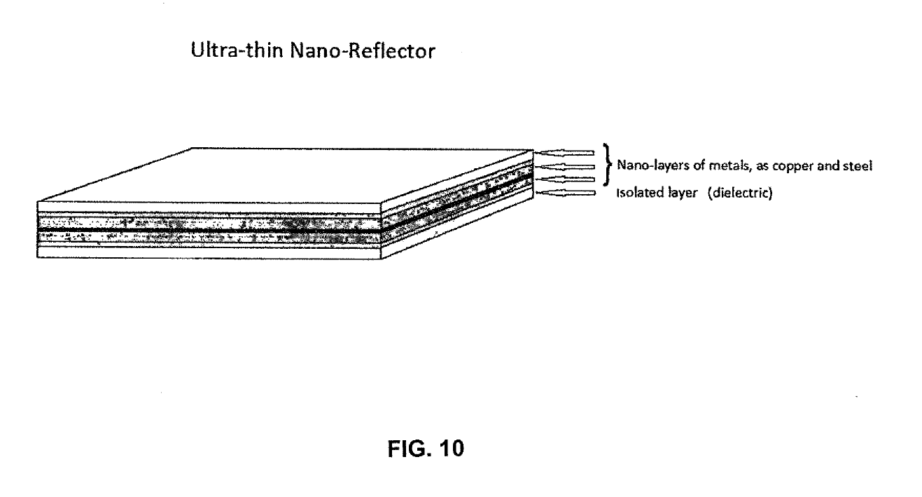

The element formed as a multi-layered film as seen in the next illustration of FIG. 10 is consisted of nano layers of different metals, among them Copper (Cu), steel and others, attached to a dielectrically/isolating material. The thin film (around 0.1 mm), is easy to integrate into the mobile devices due to its mechanical characteristics and its thin nature avoids influences on electrical existing circuits although it may be installed in proximity to electrical conductors.

The film can be installed in different manners: as a one unit, covering the full mobile device, as a smaller unit close to a specific antenna to which it is integrated, as separate pieces of film for different antennas and other methods. In addition this material can be installed externally to the mobile device, like in the case of a mobile device, in the pocket of trousers when the user puts the mobile device, on different wear items like hats, shirts etc.

The energy emitted lobe after using the integrated antenna (containing the original antenna and the film reflector) is wide enough so the communications of the mobile device with base stations is not affected. The method used allows a significant reduction of SAR, a significant reduction of the near field while the impact on the far field is relatively low.

The rerouting of the energy away from the user or in other words directing the emitted energy outwards away from the user, for example from his head, so that it is not subjected to radiation can be implemented according to the present invention by using of a directional antenna which carries out the rerouting, by using a conventional antenna with the element to carry out the rerouting, using a directional antenna in combination with the element to carry out the rerouting.

As an example—the following table shows measurements done by using the integrated antenna (original antenna and ultra-thin dish) and comparing the near and far fields (nW) before (using the existing simple antenna) and after the creation of the integrated antenna:

| | | | | Intensity-Far field | |
|---|---|---|---|---|---|
| | Fre- | Intensity-Near field | | [2 m] | |
| Host | quency | Regular | Integrated | Regular | Integrated |
| Phone | [MHz] | antenna | antenna | antenna | antenna |
| ABC | 1,961 | 80.02 | 18.34 | 15.92 | 15.92 |
| | | [nW] | [nW] | [pW] | [pW] |

| | |
|---|---|
| A reduction of 77% | No reduction |

The energy absorbed is measured in mW/g as part of the SAR testing:

| | Total SAR | Total SAR | |
|---|---|---|---|
| | [mW/g] | [mW/g] | Total |
| Host | Regular | Integrated | SAR |
| Phone | antenna | antenna | reduction |
| ABC | 0.0009 (1 gr) | 0.0004 (1 gr) | 55%-87% |
| | 0.0008 (10 gr) | 0.0001 (10 gr) | |

The present invention is not limited by the details shown since various modifications and structural changes are possible without departing from the spirit of the present invention.

What is desired to be protected by Letters Patent is set forth in particular in the appended claims. cm 1. A system for protecting a user of a mobile electronic device from radiation, comprising a unit for carrying out functional operations of a mobile electronic device; at least one antenna emitting/receiving signals in the mobile electronic device; and at least one element providing at least partial protection of a user from radiation.

2. The system of claim 1, wherein the at least one element is configured to at least partially reflect the radiation away from the user.

3. The system of claim 1, wherein the at least one element is configured to at least partially absorb the radiation.

4. The system of claim 1, wherein the at least one element is a multi-layered film.

5. The system of claim 1, wherein the at least one element is configured to operate in conjunction with the at least one antenna.

6. A method for protecting a user of a mobile electronic device from radiation, comprising the steps of carrying out functional operations by a unit for carrying out the functional operations of a mobile electronic device; emitting/receiving signals in the mobile electronic device by at least one antenna; and
providing by at least one element at least partial protection of a user from radiation.

7. The method of claim 6, wherein the step of providing protection includes at least partially reflecting the radiation away from the user by the element.

8. The method of claim 6, wherein the step of providing protection includes at least partially absorbing the radiation by the element.

9. The method of claim 6, wherein using of the element includes using a multi-layered film.

10. The method of claim 6, further comprising operating the at least one element in conjunction with the at least one antenna.
